(19) United States
(12) Patent Application Publication
(10) Pub. No.: US 2017/0053367 A1
(43) Pub. Date: Feb. 23, 2017

(54) Method for Trademark Value Assessment and System thereof

(71) Applicant: BOAO ZONGHENG NETWORK TECHNOLOGY CO., LTD, Guangzhou (CN)

(72) Inventor: Xuhui Xie, Guangzhou (CN)

(21) Appl. No.: 15/331,995

(22) Filed: Oct. 24, 2016

Related U.S. Application Data
(63) Continuation-in-part of application No. PCT/CN2015/087804, filed on Aug. 21, 2015.

(51) Int. Cl. G06Q 50/18; G06Q 30/02

(52) U.S. Cl. CPC G06Q 50/184; G06Q 30/0273; G06Q 30/0278

(57) ABSTRACT

A method for trademark value assessment and a system thereof; the method and the system obtain the trademark cost, the trademark combination coefficient, the trademark class coefficient, the trademark application duration, the trademark publicity expense and the publicity duration of the trademark to be assessed, and select different formula to calculate the trademark value with a simple system and a quick method, so that the trademark holders or purchasers can have a preliminary positioning of the trademark value quickly, thus, the prosperity of the trademark market may be promoted and the awareness of self-owned brand may be enhanced.

### CROSS-REFERENCE TO RELATED APPLICATIONS

The present application is a Continuation-In-Part Application of PCT application No. PCT/CN2015/087804 filed on Aug. 21, 2015, the contents of which are hereby incorporated by reference.

### TECHNICAL FIELD

The Invention relates to the value assessment of trademarks, and particularly to a method for trademark value assessment and a system thereof.

### BACKGROUND ART

Trademark values are accepted by more and more people and the transactions of trademark are more frequent with the development of economy. However, with complicated process, the traditional method for trademark value assessment is usually influenced by too many subjective factors and so much attention is paid to the added value of the trademark; therefore, trademark holder or purchaser is unable to objectively understand or position the basic value of the trademark quickly. The Invention integrates the trademark cost, the trademark combination type, the trademark class, the trademark application duration, the publicity expense and the publicity duration to assess the basic value of the trademark comprehensively without being influenced by the added value excessively; thus, the invention can promote the prosperity of the trademark market and indirectly enhance the awareness of self-owned brand.

### SUMMARY OF THE INVENTION

To solve the above difficulties in trademark value assessment, the Invention provides a simple and quick assessment method and a system thereof so that the trademark holders or purchasers may have a preliminary positioning of the trademark value quickly; the technical schemes are as follows:

A method for trademark value assessment, comprising the following steps:

S1: Obtaining a trademark cost, a trademark combination coefficient, a trademark class coefficient, a trademark application duration and a publicity condition of the trademark to be assessed; entering Step S2 in case the trademark is unpublicized and entering Step S3 in case the trademark is publicized;

S2: Calculating the trademark value with an assessment method for trademark of Class I based on the obtained parameters;

S3: Further obtaining a trademark publicity expense and a publicity duration and calculating the trademark value with an assessment method for trademark of Class II based on the obtained parameters.

Further, the calculation formula of the assessment method for trademark of Class I in Step S2 is:

P=X*(1+t₁)^{M}*g*e;

wherein, P is the trademark value; X is the trademark cost; t₁ is the basic annual interest rate; M is the trademark application duration; g is the trademark combination coefficient and e is the trademark class coefficient.

Further, the calculation formula of the assessment method for trademark of Class II in Step S3 is:

P=X*(1+t₁)^{M}*g*e+Y*(1+t₁)^{j/2};

wherein, P is the trademark value; X is the trademark cost; t₁ is the basic annual interest rate; M is the trademark application duration; g is the trademark combination coefficient, e is the trademark class coefficient; Y is the trademark publicity expense and j is the publicity duration.

Further, the trademark cost at least comprises one of a trademark design expense, a trademark application expense and an expense for review of refused trademark.

Further, the trademark publicity expense at least comprises one of a trademark advertising expense and a consumptive expense for trademark printing products, etc.

Further, the calculation formula of the trademark class coefficient is:

e=(1−t₂^{N})/(1−t₂);

wherein, e is a trademark class coefficient; N is a number of categories of trademark registration and t₂ is a constant factor and 0<t₂<1.

Further, the calculation method of the trademark application duration is:

taking p₁ and p₀ as the current year and the application year respectively; taking q₁ and q₀ as the current month and the application month respectively; taking s₁ and s₀ as the current date and the application date respectively;

when q₁>q₀, or q₁=q₀, but s₁≧s₀, the trademark application duration M=p₁−p₀;

when q₁<q₀, or q₁=q₀, but s₁<s₀, the trademark application duration M=p₁−p₀−1;

further, the trademark combination coefficient is determined by the type of the trademark combination; different combination type has different trademark combination coefficient.

On the other hand, the Application further discloses a system for using in any of the above items of trademark value assessment:

The trademark value assessment system comprises a data input module, a judgment module, a data operation module and a display module;

the data input module is used for reading the data inputted by users and sending it to the data operation module;

the judgment module is used for judging whether the trademark is publicized;

the data operation module is used for calculating the inputted data with different methods for trademark value assessment according to the judgment of the judgment module and figuring out the trademark value;

the display module is used for displaying the trademark value to users.

Further, the numerical value inputted by users in the relevant column of the trademark publicity expense is the basis of the judgment module for judging whether the trademark is publicized.

Further, the judgment module may inform the display module to present different data input module to users according to users' selection, so that other parameters may be further inputted.

The Invention may decrease the distraction of the added value of the trademark and calculate the trademark's intrinsic value quickly; thus, trademark holders or purchasers may have a preliminary assessment about the value of the trademark, especially of the newly applied trademark.

### BRIEF DESCRIPTION OF THE DRAWINGS

In order to illustrate the technical schemes in the embodiments of the Invention or in prior art more clearly, the drawings required in description of the embodiments or prior art will be introduced briefly as follows. Obviously, the drawings described below are just a part of the embodiments of the Invention. A person skilled in the art is able to obtain other drawings according to these drawings without any creative work.

FIG. 1 is a method schematic diagram of the preferred embodiments of the Invention;

FIG. 2 is a system schematic diagram of the preferred embodiments of the Invention;

### DETAILED DESCRIPTION OF THE PREFERRED EMBODIMENTS

A clear and full description of the technical schemes of the embodiments of the Invention will be given in combination of the drawings of the embodiments of the Invention as follows. Obviously, the described embodiments are just a part rather than the whole of the embodiments of the Invention. Based on the embodiments of the Invention, any other embodiments obtained by a person skilled in the art without any creative work will fall within the protection scope of the Invention.

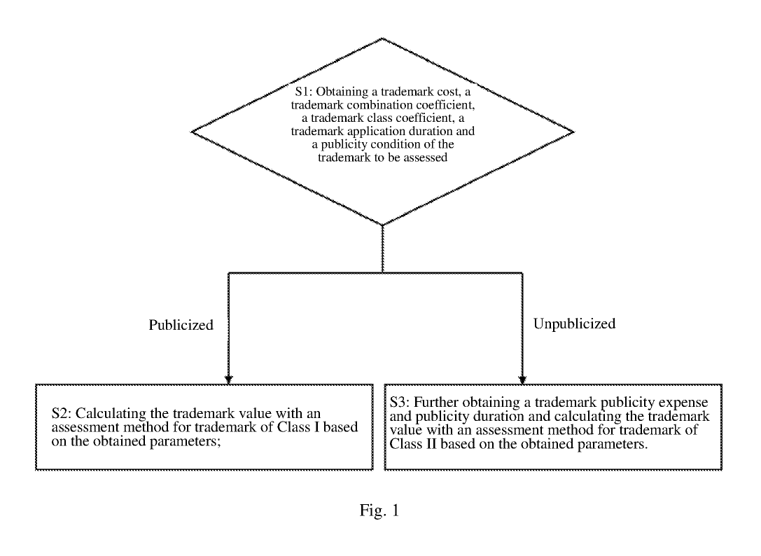

The method for trademark value assessment as shown in FIG. 1 is as follows:

S1: Obtaining a trademark cost X, a trademark combination coefficient g, a trademark class coefficient e and an application duration M of the trademark to be assessed and the publicity condition of the trademark.

Wherein, the trademark cost X at least comprises one of a trademark design expense a, a trademark application expense b and an expense for review of a refused trademark c. In the embodiment, trademark cost X=design expense a+trademark application expense b+expense for review of the refused trademark c; in other embodiments, the trademark cost X may include other expenses besides the trademark design expense a, the trademark application expense b and the expense for review of the refused trademark c.

The trademark combination coefficient g is determined by the type of the trademark combination; different combination type has different trademark combination coefficient. In the embodiment, when the trademark is a form of any of Chinese words, English words and figures, the trademark combination coefficient g=1; when the trademark is a combination of any two of Chinese words, English words and figures, the trademark combination coefficient g=1.2; when the trademark is a combination of the three of Chinese words, English words and figures, the trademark combination coefficient g=1.5; in other embodiments, the trademark combination coefficient g may be other proper numerical value; when the trademark is a combination of any two of Chinese words, English words and figures, the trademark combination coefficient g can be different numerical values based on its combination of Chinese words and English words, or of Chinese words and figures, or of English words and figures.

The calculation formula of the trademark class coefficient e is e=(1−t₂^{N})/(1−t₂); wherein, N is a number of categories of trademark registration; t₂ is a constant factor and 0<t₂<1. The number of categories of trademark registration N is determined by whether the trademark is of “multiple categories for one trademark” or “a category for one trademark”; multiple categories for one trademark refers to one same trademark is applied for registration with regard to multiple classes of goods and service items in one application of trademark registration. In the embodiment, the constant factor t₂ equals 0.9; in other embodiments, the constant factor t₂ may be other numerical values as per requirements only if 0<t₂<1.

The calculation method of the trademark application duration is: taking p₁ and p₀ as the current year and the application year respectively; taking q₁ and q₀ as the current month and the application month respectively; taking s₁ and s₀ as the current date and the application date respectively;

when q₁>q₀, or q₁=q₀, but s₁≧s₀, the trademark application duration M=p₁−p₀;

when q₁<q₀, or q₁=q₀, but s₁<s₀, the trademark application duration M=p₁−p₀−1;

In other embodiments, the trademark application duration M does not have to be a specific date and only the month and the year need to be compared.

Entering Step S2 in case the trademark is unpublicized; calculating the trademark value P with the assessment method for trademark of Class I based on the obtained trademark cost X, trademark combination coefficient g, trademark class coefficient e and application duration M of the trademark to be assessed;

The calculation formula of the assessment method for trademark of Class I is P=X*(1+t₁)^{M}*g*e; wherein, t₁ is the basic annual interest rate; in the embodiment, t₁ equals 0.0325; in other embodiments, the basic annual interest rate t₁ may be other proper values according to the interest rate of the bank.

Entering Step S3 in case the trademark is publicized; filling the trademark publicity expense Y and the publicity duration j, and then calculating the trademark value with the assessment method for trademark of Class II based on the obtained trademark cost X, trademark combination coefficient g, trademark class coefficient e, application duration M, publicity expense Y and publicity duration j of the trademark to be assessed.

The trademark publicity expense Y at least comprises one of the trademark advertising expense h and the consumptive expense for trademark printing products i, etc. In the embodiment, trademark publicity expense Y=trademark advertising expense h+consumptive expense for trademark printing products i; the trademark publicity expense Y may include other costs besides the trademark advertising expense h and the consumptive expense for trademark printing products i.

The calculation formula of the assessment method for trademark of Class II is P=X*(1+t₁)^{M}*g*e+Y*(1+t₁)^{j/2}; wherein, X is the trademark cost; t₁ is the basic annual interest rate; M is the trademark application duration; g is the trademark combination coefficient, e is the trademark class coefficient; Y is the trademark publicity expense and j is the publicity duration. The publicity duration j is inputted by users with the unit of year.

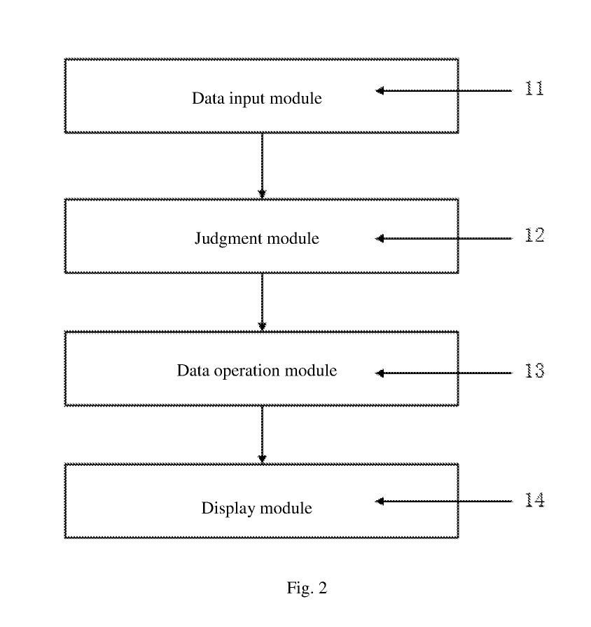

The system for trademark value assessment as shown in FIG. 2 is as follows:

The trademark value assessment system comprises a data input module 11, a judgment module 12, a data operation module 13 and a display module 14;

The data input module 11 is used for reading the data inputted by users and sending it to the data operation module 13; in the embodiment, the data inputted by the data input module 11 comprises the trademark cost X, trademark combination coefficient g, trademark class coefficient e, the trademark application duration M, the trademark publicity expense Y and the publicity duration j of the trademark to be assessed. The trademark combination coefficient g is calculated in the system background automatically according to the specific type of the trademark selected by users. The trademark class coefficient e refers to the number of the registered categories of the trademark inputted by users. The trademark application duration M is calculated according to the current date in the background after the users input the trademark application date in a calendar selection interface.

The judgment module 12 is used for judging whether the trademark is publicized. The numerical value inputted by users in the relevant column of the trademark publicity expense Y is the basis of the judgment module 12 for judging whether the trademark is publicized. When the trademark selected by users is a combined trademark, the judgment module 12 may inform the display module 14 to present different data input module 11 to users according to users' selection, so that a specific combination type of the trademark may be further inputted.

The data operation module 13 is used for calculating the inputted data with different methods for trademark value assessment according to the judgment of the judgment module 12 and figuring out the trademark value P by calculating the inputted data with the assessment method for trademark of Class I in case the trademark is unpublicized; in case the trademark is publicized, the inputted data shall be calculated with the assessment method for trademark of Class II to obtain the trademark value P;

the display module 14 is used for displaying the ultimate trademark value to users.

In Embodiment 1, the data input module 11 records that the inputted trademark design cost a=2000 yuan; the trademark application expense b=2000 yuan; the cost for review of refused trademark c=1000 yuan, the trademark combination type is of the combination of Chinese words, English words and figures (Chinese words, English words and figures combinations); the trademark class coefficient N=10; the trademark application date is 2010.03.20 (i.e., the trademark application year p₀=2010; the month q₀=03 and the date s₀=20).

Then, the trademark cost X=a+b+c=5000 yuan and the trademark combination coefficient g=1.5. In the embodiment, the constant factor t₂=0.9; therefore, the trademark class coefficient e=(1−t₂^{N})/(1−t₂)=(1−0.9¹⁰)/(1−0.9)=6.513215599. Provided that the current date is 2015.03.25, then the current year p₁=2015; the month q₁=03 and the date s₁=25; because q₁=q₀ and s₁ s₀, then the trademark application duration M=p₁−p₀=5. The basic annual interest rate is defaulted as t₁=3.25%.

The judgment module 12 automatically judges that the trademark is unpublicized according to the unfilled trademark publicity expense Y and the publicity duration j, and informs data operation module 13 to call the assessment formula for trademark of Class I and calculate the trademark value P; therefore, the trademark value P=X*(1+t₁)^{M}*g*e=5000*(1+0.0325)⁵*1.5*6.513215599=57320.11 yuan (it records 2 decimal places by default); then the display module 14 displays the trademark value P=57320.11 yuan to users.

In Embodiment 2, the data input module 11 records that the inputted trademark design cost a=2000 yuan; the trademark application expense b=2000 yuan; the expense for review of refused trademark c=1000 yuan, the trademark combination type is any one of Chinese words, English words and figures; the trademark class coefficient N=1; the trademark application date is 2010.03.20 (i.e., the trademark application year p₀=2010; the month q₀=03 and the date s₀=20); the trademark advertising expense h=5000 yuan; the consumptive expense for trademark printing products i=1000 yuan and the publicity duration j=6.

Then, the trademark cost X=a+b+c=5000 yuan and the trademark combination coefficient g=1. In the embodiment, the constant factor t₂=0.9; therefore, the trademark class coefficient e=(1−t₂^{N})/(1−t₂)=(1−0.9¹)/(1−0.9)=1. Provided that the current date is 2015.02.15, then the current year p₁=2015; the month q₁=02 and the date s₁=15; because q₁<q₀, therefore the trademark application duration M=p₁−p₀−1=4. The basic annual interest rate is defaulted as t₁=3.25% and the trademark publicity cost Y=h+i=6000 yuan.

The judgment module 12 automatically judges that the trademark is unpublicized according the filled trademark publicity expense Y and the publicity duration j, and informs data operation module 13 to call the assessment formula for trademark of Class II and calculate the trademark value P; therefore, the trademark value P=X*(1+t₁)^{M}*g*e+Y*(1+t₁)^{j/2}=5000*(1+0.0325)⁴*1*1+6000*(1+0.0325)^{6/2}=12286.60 yuan (it records 2 decimal places by default); then the display module 14 displays the trademark value P=12286.60 yuan to users.

The above are the preferred embodiments rather than the limitations of the Invention. Any amendment, equivalent replacement and improvement made within the range of the spirit and rule of the Invention shall be included in the protection scope of the Invention.

1. A method for trademark value assessment, wherein, the method comprises the following steps:
S1: Obtaining a trademark cost, a trademark combination coefficient, a trademark class coefficient, a trademark application duration and the publicity condition of the trademark to be assessed; entering Step S2 in case the trademark is unpublicized and entering Step S3 in case the trademark is publicized;
S2: Calculating the trademark value with an assessment method for trademark of Class I based on the obtained parameters;
S3: Further obtaining a trademark publicity expense and publicity duration and calculating the trademark value with an assessment method for trademark of Class II based on the obtained parameters.

2. The method for trademark value assessment according to claim 1, wherein, the calculation formula of the assessment method for trademark of Class Tin Step S2 is:
P=X*(1+t₁)^{M}*g*e;
wherein, P is the trademark value; X is the trademark cost; t₁ is the basic annual interest rate; M is the trademark application duration; g is the trademark combination coefficient and e is the trademark class coefficient.

3. The method for trademark value assessment according to claim 1, wherein, the calculation formula of the assessment method for trademark of Class II in Step S3 is:
P=X*(1+t₁)^{M}*g*e+Y*(1+t₁)^{j/2};
wherein, P is the trademark value; X is the trademark cost; t₁ is the basic annual interest rate; M is the trademark application duration; g is the trademark combination coefficient, e is the trademark class coefficient; Y is the trademark publicity expense and j is the publicity duration.

4. The method for trademark value assessment according to claim 1, wherein, the trademark cost at least comprises one of a trademark design cost, a trademark application expense and an expense for review of refused trademark.

5. The method for trademark value assessment according to claim 1, wherein, the trademark publicity expense at least comprises one of a trademark advertising expense and a consumptive expense for trademark printing products.

6. The method for trademark value assessment according to claim 1, wherein, the calculation formula of the trademark class coefficient is:
e=(1−t₂^{N})/(1−t₂);
wherein, e is a trademark class coefficient; N is a number of categories of trademark registration and t₂ is a constant factor and 0<t₂<1.

7. The method for trademark value assessment according to claim 1, wherein, the calculation method of the trademark application duration is:
taking p₁ and p₀ as the current year and the application year respectively; taking q₁ and q₀ as the current month and the application month respectively; taking s₁ and s₀ as the current date and the application date respectively;
when q₁>q₀, or q₁=q₀, but s₁≧s₀, the trademark application duration M=p₁−p₀;
when q₁<q₀, or q₁=q₀, but s₁<s₀, the trademark application duration M=p₁−p₀−1.

8. A system for trademark value assessment according to claim 1, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

9. The system for trademark value assessment according to claim 8, wherein, the numerical value inputted by users in the relevant column of the trademark publicity expense is the basis of the judgment module for judging whether the trademark is publicized.

10. The system for trademark value assessment according to claim 8, wherein, the judgment module may inform the display module to present different data input modules to users according to users' selection, so that other parameters may be further inputted.

11. A system for trademark value assessment according to claim 2, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

12. A system for trademark value assessment according to claim 3, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

13. A system for trademark value assessment according to claim 4, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

14. A system for trademark value assessment according to claim 5, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

15. A system for trademark value assessment according to claim 6, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

16. A system for trademark value assessment according to claim 7, wherein,
the trademark value assessment system comprises a data input module, a judgment module, a data operation module and a display module;
the data input module is used for reading the data inputted by users and sending it to the data operation module;
the judgment module is used for judging whether the trademark is publicized;
the data operation module is used for calculating the inputted data with different methods for trademark value assessment according to the judgment of the judgment module and figuring out the trademark value;
the display module is used for displaying the trademark value to users.

17. The system for trademark value assessment according to claim 11, wherein, the numerical value inputted by users in the relevant column of the trademark publicity expense is the basis of the judgment module for judging whether the trademark is publicized.

18. The system for trademark value assessment according to claim 12, wherein, the numerical value inputted by users in the relevant column of the trademark publicity expense is the basis of the judgment module for judging whether the trademark is publicized.

19. The system for trademark value assessment according to claim 13, wherein, the numerical value inputted by users in the relevant column of the trademark publicity expense is the basis of the judgment module for judging whether the trademark is publicized.

20. The system for trademark value assessment according to claim 14, wherein, the numerical value inputted by users in the relevant column of the trademark publicity expense is the basis of the judgment module for judging whether the trademark is publicized.

21. The system for trademark value assessment according to claim 15, wherein, the numerical value inputted by users in the relevant column of the trademark publicity expense is the basis of the judgment module for judging whether the trademark is publicized.

22. The system for trademark value assessment according to claim 16, wherein, the numerical value inputted by users in the relevant column of the trademark publicity expense is the basis of the judgment module for judging whether the trademark is publicized.

23. The system for trademark value assessment according to claim 11, wherein, the judgment module may inform the display module to present different data input modules to users according to users' selection, so that other parameters may be further inputted.

24. The system for trademark value assessment according to claim 12, wherein, the judgment module may inform the display module to present different data input modules to users according to users' selection, so that other parameters may be further inputted.

25. The system for trademark value assessment according to claim 13, wherein, the judgment module may inform the display module to present different data input modules to users according to users' selection, so that other parameters may be further inputted.

26. The system for trademark value assessment according to claim 14, wherein, the judgment module may inform the display module to present different data input modules to users according to users' selection, so that other parameters may be further inputted.

27. The system for trademark value assessment according to claim 15, wherein, the judgment module may inform the display module to present different data input modules to users according to users' selection, so that other parameters may be further inputted.

28. The system for trademark value assessment according to claim 16, wherein, the judgment module may inform the display module to present different data input modules to users according to users' selection, so that other parameters may be further inputted.
